(19) United States
(12) Patent Application Publication
(10) Pub. No.: US 2025/0260172 A1
(43) Pub. Date: Aug. 14, 2025

(54) Method and device for controlling at least one reconfigurable intelligent surface

(71) Applicant: ORANGE, ISSY-LES-MOULINEAUX (FR)

(72) Inventors: Youssef HUSSEIN, CHATILLON CEDEX (FR); Thierry CLESSIENNE, CHATILLON CEDEX (FR)

(21) Appl. No.: 19/043,871

(22) Filed: Feb. 3, 2025

(30) Foreign Application Priority Data
Feb. 8, 2024 (FR) 2401237

(51) Int. Cl. H01Q 15/00; H01Q 3/36; H04W 88/08

(52) U.S. Cl. CPC H01Q 15/0086; H01Q 3/36; H01Q 15/002; H04W 88/08

(57) ABSTRACT

A method for controlling at least one reconfigurable intelligent surface, called an “intermediate surface”, positioned between an access point and at least one other reconfigurable intelligent surface, called a “main surface”, configured to serve a given geographical area. The method includes: determining respective phase shifts of reflective elements of the intermediate surface such that: signals emitted by the access point to exchange data with at least one user terminal situated in the geographical area are reflected by the intermediate surface toward the at least one main surface, and the power of the signals reflected is greater than a given threshold or maximized; and controlling the reflective elements of the intermediate surface by using the determined phase shifts.

### CROSS REFERENCE TO RELATED APPLICATIONS

The present application claims priority to French Patent Application No FR2401237, filed on Feb. 8, 2024, the content of which is incorporated herein by reference in its entirety.

### TECHNICAL FIELD

The disclosed technology belongs to the field of wireless communications systems. It more specifically relates to a method for controlling at least one reconfigurable intelligent surface associated with a cell of a communication network served by a base station, as well as a control device configured to implement such a control method.

### DISCUSSION OF RELATED TECHNOLOGY

As is known, a reconfigurable reflective surface, hereinafter referred to as a “RIS” (Reconfigurable Intelligent Surface) for the sake of brevity, is a surface including a plurality of elements, the respective reflective properties of which can be modified. For more details concerning the operation of an RIS, one may for example consult the following document “Smart Radio Environments Empowered by Reconfigurable Intelligent Surfaces: How it Works, State of Research, and Road Ahead”, M. D. Renzo, A. Zappone, M. Debbah, M. Alouini, C. Yuen, J. D. Rosny, and S. Tretyakov, IEEE Journal on Selected 5 Areas in Communications, pages 2450-2524, 2020.

In practice, such an RIS is intended to reflect incident radio signals in a passive manner, i.e. without amplification of said incident radio signals by amplifiers (or by low-noise amplifiers or by power amplifiers). By modifying the reflective properties of each element of the RIS, for example by individually modifying the phase shift introduced by each of these reflective elements, it is possible to influence the way in which the incident radio signals are reflected by the RIS and, ultimately, to influence the propagation channel taken by these radio signals.

For this reason, an RIS constitutes an effective means for allowing exchanges of data between a base station and geographical areas which would otherwise be poorly served (or not served at all.) This aspect is for example illustrated with FIG. 1 which schematically represents an example of a wireless communications system using an RIS 12.

As illustrated by FIG. 1, the wireless communication system includes a base station 11 installed at the highest point of a tower block, which must exchange data (over a downlink and/or an uplink) with user terminals situated in a geographical area ZG to be served. In this example, the direct paths between the base station 11 and the geographical area ZG to be served are obstructed by buildings, so that the radio signals taking these direct paths are heavily attenuated, or even blocked.

By placing the RIS 12 on an adjacent tower block, it is possible to improve the reflection of the incident radio signals by this adjacent tower block, and to thus promote an indirect path between the geographical area ZG and the base station 11, by way of the RIS 12. For this purpose, a control device (not shown on FIG. 1, and for example incorporated into the base station 11), determines the appropriate phase shifts of the reflective elements of the RIS 12 to allow this latter to serve the geographical region ZG. Once determined, these phase shifts are transmitted to the RIS 12 via a backhaul network. A command module of the RIS 12 is then used to control the reflective elements so that these latters introduce phase shifts matching those determined by the control device.

The advantages related to the use of an RIS are not limited to the possibility of serving areas which would otherwise remain poorly served (or not served at all). Specifically, the energy consumption of an RIS is negligible with respect to that of a base station. Furthermore, an RIS is simpler to install from a technical and regulatory point of view. All these aspects justify the high degree of interest in this technology and the desire of operators to boost its development, particularly in the context of the deployment of wireless communication systems of 5G-Advanced or 6G type, particularly suited to the context of spatial multiplexing of different user terminals (multi-user multiple input multiple output or MU-MIMO).

The fact remains that the use of the single RIS 12 to create an indirect path between the base station 11 and the geographical area ZG may not be enough to allow a plurality of terminals to be served with sufficient quality of service.

Specifically, the base station 11 is typically equipped with an array of antennas including a plurality of antennas, and the maximum number of user terminals which can be spatially multiplexed, when the propagation channels are sufficiently decorrelated with one another, corresponds to the minimum out of the number of antennas of the antenna array of the base station 11 and the number of elements of the RIS 12.

In practice, the number of user terminals that can actually be spatially multiplexed depends on the rank of the matrix of the propagation channel between the different user terminals and the different antennas of the antenna array of the base station 11. However, in the case of the wireless communication system of FIG. 1 in which an RIS 12 is used to extend the coverage of a service in situations of very degraded propagation, this rank cannot be greater than the rank of the matrix of the propagation channel between the different antennas of the antenna array of the base station 11 and the different elements of the RIS 12. However, this matrix of the propagation channel between the base station 11 and the RIS 12 can in practice have a fairly low rank, in particular in the case of frequencies greater than 30 Gigahertz (GHz) (for example for millimeter waves), or even greater than 1 Terahertz (THz), and/or in the situation where the RIS 12 is located in a situation of direct line of sight (LOS) with the base station 11. Thus, in such a case, the propagation channel between the base station 11 and the RIS 12 acts as a bottleneck which can greatly limit the achievable performance in terms of spatial multiplexing gains.

To remedy these drawbacks, provision has been made for positioning a plurality of RISs between a base station and a geographical area to be served. More specifically, said plurality of RISs includes a so-called “main” RIS and a plurality of so-called “intermediate” RISs:
the main RIS being arranged between the intermediate RISs and the geographical area to be served,
the intermediate RISs being arranged between the base station and the main RIS.

The term “main RIS arranged between the intermediate RISs and the geographical area to be served” should be understood to mean that, in the downlink direction (or in the uplink direction respectively), radio signals coming from each intermediate RIS (or coming from the geographical area respectively) reach the geographical area (or each intermediate RIS respectively) via said main RIS, after reflection thereby. Similarly, the term “intermediate RIS arranged between the base station and the main RIS” should be understood to mean that, in the downlink direction (or in the uplink direction respectively) radio signals coming from the base station (or coming from the main RIS respectively) reach the main RIS (or the base station respectively) via an intermediate RIS, after reflection thereby.

These considerations result, in particular, in a main RIS being arranged closer to the geographical area to be served than the intermediate RISs.

Such a configuration in which a plurality of RISs is used is for example illustrated with FIG. 2.

In FIG. 2, and according to similar considerations to those described above for FIG. 1, the wireless communication system includes a base station 21 which must exchange data with user terminals situated in a geographical area ZG_4 to be served. The wireless communication system further includes a plurality of RISs, namely a main RIS 20_4 and three intermediate RISs 20_1, 20_2, 20_3.

As illustrated by FIG. 2, at least some of the radio signals coming from the base station 21 may reach the geographical area ZG_4 by being reflected, first by the intermediate RISs 20_1, 20_2, 20_3, then by the main RIS 20_4, and conversely, according to the uplink or downlink direction in question.

The introduction of the intermediate RISs 20_1, 20_2, 20_3 makes it possible to increase the rank of the matrix of the propagation channel between the base station 21 and the main RIS 20_4, by increasing the number of indirect paths usable between said base station 21 and said main RIS 20_4, each intermediate RIS 20_1, 20_2, 20_3 making it possible to introduce a distinct indirect path between said base station 21 and said main RIS 20_4.

In the prior art, each intermediate RIS 20_1, 20_2, 20_3 is configured to reflect signals toward the main RIS 20_4 on the basis of very general assumptions relating to the respective positions of said intermediate RISs 20_1, 20_2, 20_3 and main RIS 20_4. Although this solution results in an increase in the rank of the matrix of the propagation channel between the base station 21 and the main RIS 20_4, it results in a lack of directivity and concentration of the signals reflected toward the main RIS 20_4.

### SUMMARY

The disclosed technology makes provision for a solution for improving the directivity and concentration of the signals reflected by an intermediate RIS, both toward a main RIS in the context of a communication downlink and toward an access point (e.g. a base station) in the context of a communication uplink, and thus to provide an excellent quality of service to users located in a geographical area served by said main RIS.

For this purpose, and according to a first aspect, the disclosed technology relates to a method for controlling at least one reconfigurable intelligent surface, the so-called “intermediate surface”, positioned between an access point and at least one other reconfigurable intelligent surface, the so-called “main surface”, configured to serve a given geographical area covered by the access point. Said method includes steps of:
determining phase shifts of reflective elements of said at least one intermediate surface such that:
   signals emitted by the access point are reflected by said intermediate surface toward said at least one main surface to exchange data with at least one user terminal situated in the geographical area served by said at least one main surface,
   the power of the signals reflected by said intermediate surface toward said at least one main surface is greater than a given threshold or maximized, said power being a function parameterized by said phase shifts, angles of the signals emitted by the access point toward said intermediate surface, as well as angles of the signals reflected by said intermediate surface toward said at least one main surface,
controlling the reflective elements of said intermediate surface by means of the determined phase shifts.

This first aspect of the disclosed technology falls within the context of a communication downlink between the access point and said at least one user terminal with which data are exchanged. It is however important to note that these provisions are not limiting of the disclosed technology, this latter also being able to be implemented, according to similar technical provisions, in the context of a communication uplink between said at least one user terminal and the access point.

Thus, and according to another aspect, the disclosed technology relates to a method for controlling at least one reconfigurable intelligent surface, the so-called “intermediate surface”, positioned between an access point and at least one other reconfigurable intelligent surface, the so-called “main surface”, configured to serve a given geographical area covered by the access point. Said method includes steps of:
determining phase shifts of reflective elements of said intermediate surface such that:
   signals, emitted by at least one user terminal situated in said geographical area and reflected by said at least one main surface toward said intermediate surface, are reflected by said intermediate surface toward the access point to exchange data with the access point,
   the power of the signals reflected by said intermediate surface toward the access point is greater than a given threshold or maximized, said power being a function parameterized by said phase shifts, angles of the signals reflected by said at least one main surface toward said intermediate surface, as well as angles of the signals reflected by said intermediate surface toward the access point,
controlling the reflective elements of said intermediate surface by means of the determined phase shifts.

The fact of determining the phase shifts of an intermediate surface in this way makes it possible to take into account the precise physical reality in which said intermediate surface is located.

This physical reality refers to:
in the context of a communication downlink, the angles of the signals reaching the intermediate surface from the access point (these angles are thus angles of “incidence” from the access point toward the intermediate surface) as well as the angles of signals reaching said at least one main surface from the intermediate surface (these angles are thus angles of “departure” from the intermediate surface toward said at least one main surface),
in the context of a communication uplink, the angles of the signals reaching the intermediate surface from said at least one main surface (these angles are thus angles of “incidence” from said at least one main surface toward the intermediate surface) and the angles of signals reaching the access point from the intermediate surface (these angles are thus angles of “departure” from the intermediate surface toward the access point).

Proceeding in this way makes it possible to configure the intermediate surface advantageously so that the reflection of signals toward said at least one main surface in the context of a communication downlink (or toward the access point in the context of a communication uplink respectively) is done in a much more directed and concentrated manner than in the prior art. In this way, the main surface may serve the antennas of user equipment items situated in the geographical area very effectively in the context of a communication downlink (or the data emitted by user equipment items situated in the geographical area arrive at the access point very effectively in the context of a communication uplink, respectively).

In particular embodiments, the control method (in the context of a communication downlink and/or a communication uplink) can moreover include one or more of the following features, taken in isolation or in any technically possible combination.

In particular embodiments, in which the communication link under consideration is a downlink, the phase shifts are also determined such that the power of signals reflected by said intermediate surface directly toward at least one antenna of said at least one user terminal is less than a given threshold or minimized.

Although each intermediate surface is configured to reflect signals coming from the access point toward the main surface in the context of a communication downlink, there may be a risk of some of these reflections being uncontrolled so that they are ultimately directed elsewhere, such as for example directly toward an antenna of the geographical area. Hence, the provisions envisioned here advantageously make it possible to reduce interference relating to such reflections directly directed toward antennas of the geographical area.

In particular embodiments:
the access point is in a situation of direct line of sight with all or part of said at least one intermediate surface, and/or
each main surface is in a situation of direct line of sight with all or part of the geographical area it serves, and/or
all or part of said at least one main surface is in a situation of direct line of sight with all or part of said at least one intermediate surface.

In particular embodiments, the method is implemented to control a plurality of intermediate surfaces positioned between the access point and said at least one main surface, the steps of determining phase shifts and controlling being executed for each intermediate surface of said plurality of intermediate surfaces.

In particular embodiments, intermediate surfaces are arranged along different respective directions with respect to the access point.

In particular embodiments, intermediate surfaces are arranged along different respective directions with respect to said at least one main surface.

In particular embodiments, the phase shifts are also determined such that the power of signals reflected by the intermediate surface for which phase shifts are determined toward at least one other intermediate surface is less than a given threshold or minimized.

According to similar considerations to those mentioned above, there may be a risk of reflections generated by an intermediate surface being uncontrolled so as to be ultimately directed toward at least one other intermediate surface. Hence, the provisions envisioned here advantageously make it possible to reduce interference relating to such reflections directed toward at least one other intermediate surface.

In particular embodiments, a set of reconfigurable intelligent surfaces is associated with the access point, said set including at least one surface selected as intermediate surface and at least one surface selected as main surface so as to optimize a determined communication performance criterion for at least one user terminal situated in the geographical area served by said at least one main surface, the steps of determining and controlling being implemented for the surfaces thus selected in said set of surfaces.

These provisions advantageously make it possible to envision a modification of the respective roles (intermediate, main) played by the surfaces of the set associated with the access point. In this way, all the geographical areas respectively associated with the surfaces of the set associated with the access point can be effectively served.

In particular embodiments, the steps of determining the phase shifts and controlling form a set of steps, said set of steps being iterated and each iteration is implemented for the selected surfaces so as to optimize the communication performance criterion during said iteration.

In particular embodiments, said set of steps is iterated according to a determined time increment corresponding to the coherence time associated with the signals emitted by the access point or by said at least one user terminal, or to a determined slot of said coherence time.

Choosing a time increment corresponding to the coherence time or else to a slot thereof falls in the category of, for example, considerations relating to a trade-off between optimality of the communication performance criterion and computational load. More specifically, if the time increment is chosen to be equal to one slot of the coherence time, the optimality of the communication performance criterion is privileged over the reduction in computational load and vice versa if the time increment is chosen to be equal to the coherence time).

In particular embodiments, in which the communication link under consideration is a downlink, a set of reconfigurable intelligent surfaces is associated with the access point, said set including a plurality of main surfaces, the step of determining the phase shifts including the determining, from among the plurality of main surfaces, of a main surface, the so-called “focusing surface”, toward which the intermediate surface is intended to reflect signals, said determining of the focusing surface being done so as to optimize a determined communication performance criterion for at least one user terminal situated in the geographical area served by said focusing surface. Furthermore, the steps of determining the phase shifts and controlling form a set of steps, said set of steps being iterated.

In particular embodiments, in which the communication link under consideration is an uplink, a set of reconfigurable intelligent surfaces is associated with the access point, said set including a plurality of main surfaces, the step of determining the phase shifts including the determining, from among the plurality of main surfaces, of a main surface, the so-called “transmitting surface” from which the intermediate surface is intended to receive signals to reflect them toward the access point, said determining of the transmitting surface being done so as to optimize a determined communication performance criterion for at least one user terminal situated in the geographical area served by said transmitting surface. Furthermore, the steps of determining the phase shifts and controlling form a set of steps, said set of steps being iterated.

In particular embodiments, the communication performance criterion is representative of at least one element from among:
a bitrate of the data which can be exchanged between the access point and said at least one user terminal situated in the geographical area served by each selected main surface,
a level of quality of service of the exchanges of data between the access point and said at least one user terminal situated in the geographical area served by each selected main surface,
an energy efficiency of the exchanges of data between the access point and said at least one user terminal situated in the geographical area served by each selected main surface,
a signal-to-noise ratio of the exchanges of data between the access point and said at least one user terminal situated in the geographical area served by each selected main surface.

According to another aspect, the disclosed technology relates to a computer program including instructions for implementing a control method according to the disclosed technology when said program is executed by a computer.

This program can use any programming language, and be in the form of source code, object code, or intermediate code between source code and object code, such as in a partially compiled form, or in any other desirable form.

According to another aspect, the disclosed technology relates to an information or recording medium readable by a computer on which is recorded a computer program according to the disclosed technology.

The information or recording medium can be any entity or device capable of storing the program. For example the support may include a storage means, such as a ROM, for example a CD-ROM or a microelectronic circuit ROM, or else a magnetic recording means, for example a hard disk.

Moreover, the information or recording medium can be a transmissible medium such as an electrical or optical signal, which can be conveyed via an electrical or optical cable, by radio or by other means. The program according to the disclosed technology can in particular be downloaded over a network of Internet type.

Alternatively, the information or recording medium can be an integrated circuit into which the program is incorporated, the circuit being suitable for executing or for being used in the execution of the method in question.

According to another aspect, the disclosed technology relates to a control device including means configured to implement a control method according to the disclosed technology.

According to another aspect, the disclosed technology relates to a wireless communication system including an access point, a plurality of reconfigurable intelligent surfaces associated with the access point, and also a control device according to the disclosed technology.

### BRIEF DESCRIPTION OF THE DRAWINGS

Other features and advantages of the disclosed technology will become apparent from the description given below, with reference to the appended drawings which illustrate an exemplary embodiment thereof, without any limitation. On the figures:

FIG. 1, already described, schematically represents an example of a wireless communication system of the prior art, in which a single RIS is used to serve a given geographical area;

FIG. 2, already described, schematically represents an example of a wireless communication system of the prior art, in which a plurality of intermediate RISs and a main RIS are used to serve a given geographical area;

FIG. 3 schematically represents a wireless communication system according to a particular embodiment of the disclosed technology;

FIG. 4 schematically represents an example of a hardware architecture of a control device belonging to the wireless communication system of FIG. 3;

FIG. 5 represents, in the form of a block diagram, a particular embodiment of a control method executed by the device of FIG. 4;

FIG. 6 represents, in the form of a block diagram, another particular embodiment of the control method according to the disclosed technology;

FIG. 7 is an alternative schematic representation of FIG. 3, wherein RISs belonging to the wireless communication system are respectively associated with geographical areas to be served.

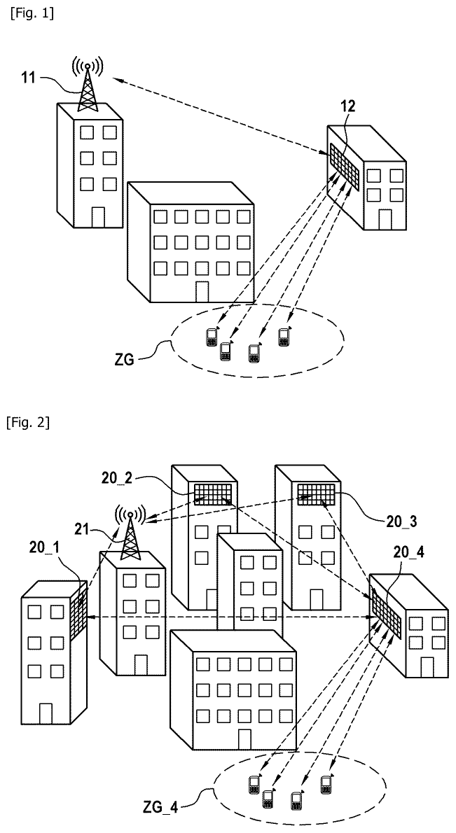

### DESCRIPTION OF ILLUSTRATIVE EMBODIMENTS

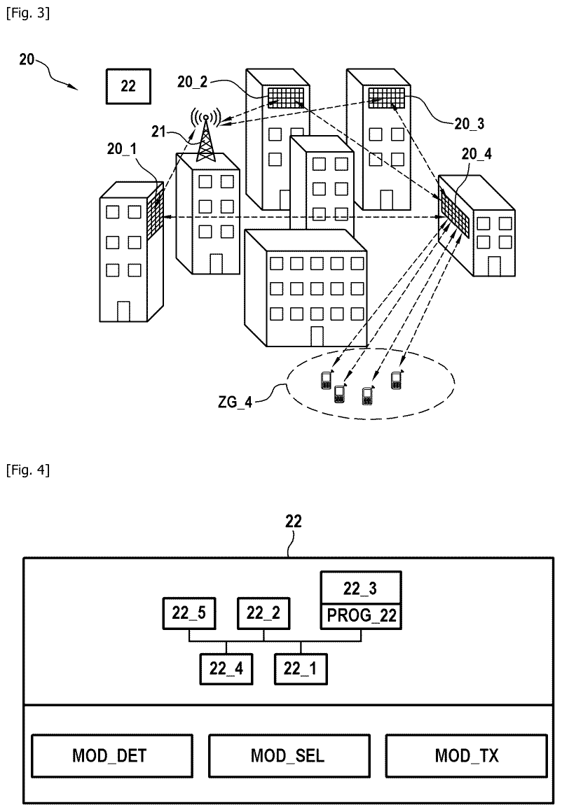

FIG. 3 schematically represents a wireless communication system 20 according to a particular embodiment of the disclosed technology.

The system 20 is based on the configuration already described above with reference to FIG. 2. Consequently, the elements mentioned in relation to FIG. 2 are repeated here with identical reference numbers.

Thus, and as illustrated by FIG. 3, the system 20 includes a base station 21 here serving at least one communication cell (not illustrated on the figures), a main RIS 20_4 configured to serve a given geographical area ZG_4 of said communication cell, as well as intermediate RISs 20_1, 20_2, 20_3. The plurality of RIS 20_i (i being an integer index between 1 and 4) belonging to the system 20 form a set of RIS hereinafter written “set E”.

While the integer index i is used here to generally refer to the RISs 20_i of the set E, in the description use will also be made, more specifically, of an integer index j, between 1 and 3, to refer solely to the intermediate RISs 20_j of the set E.

As mentioned above, each intermediate RIS 20_j therefore makes it possible to establish a distinct indirect path between the base station 21 and the geographical area ZG_4, the main RIS 20_4 being located on a plurality of such distinct indirect paths established by the different intermediate RISs i20_j.

It should be noted that the fact of considering three intermediate RISs 20_1, 20_2, 20_3 constitutes only one variant implementation of the disclosed technology. In general, no limitation is attached to the number of intermediate RISs which can be envisioned, such as for example more or less than three intermediate RISs, particularly a single intermediate RIS. This number can also be greater than or less than the number of antennas equipping the base station 21.

Moreover, and although only a single main RIS 20_4 is envisioned in this embodiment, the disclosed technology covers yet other embodiments in which several main RISs may be envisioned, as described in more detail further on. In general, the disclosed technology is not limited by these aspects, it being understood that the number of main RISs is preferably less than or equal to the number of intermediate RISs, so as to limit the number of propagation channels between main RISs and antennas to be served (the number of propagation channels having an influence on the quantity of computations to be made in the context of the disclosed technology).

According to similar considerations, the system 20 may also include a plurality of base stations, and each base station may serve one or more communication cells. In practice, the principles described hereinafter can be extended by those skilled in the art to such configurations.

Moreover, the fact of considering that the incident signals intended to be reflected by the intermediate RISs 20_j are emitted by a base station constitutes only one variant implementation of the disclosed technology. In general, the emission of said signals can be done by any access point of a design known per se.

The base station 21 includes an array of antennas (not shown on the figures) including an integer number M>1 of antennas. The antenna array is for example a uniform linear array (or ULA) in which the M antennas are arranged with a constant separation along one dimension, or else a uniform rectangular planar array (or URPA) in which the M antennas are coplanar and arranged along two dimensions with constant respective separations, etc.

As illustrated by FIG. 3, the RISs 20_i are spatially distributed between the base station 21 and the geographical area ZG_4 to be served, in order to improve the communication performance between the base station 21 and antennas located in the geographical area ZG_4 to be served.

More particularly, in the embodiment described here, it is considered without any limitation that said antennas equip user terminals (or UE for User Equipment), each user terminal being equipped, in the example envisioned here, with a single antenna. A user terminal can for example take the form of a mobile telephone, such as for example a smart mobile phone (or smartphone), a digital tablet, a laptop computer, a personal assistant, a connected watch, an electronic reader, etc. In general, no limitation is attached to the form taken by a user terminal.

The disclosed technology is of course not limited to the scenario in which each user terminal is equipped with a single antenna. Thus, nothing precludes the envisioning of one or more user terminals situated in the geographical area ZG_4 being equipped with several antennas.

Moreover, in the example of FIG. 3, the geographical area ZG_4 is represented as being a connected area (i.e. forming a single whole). However, nothing precludes the envisioning of the area ZG_4 including a plurality of discontinuous sub-areas (i.e. each of said sub-areas forms a connected component of the area ZG_4).

In a manner known per se, each RIS 20_i includes a command module (not shown on the figures) and reflective elements (not shown on the figures) the reflection properties of which are modifiable by the command module such as to influence the way in which radio signals incident on said reflective elements are reflected by these.

The command module includes, for example, at least one processor and at least one memory (magnetic hard disk, electronic memory, optical disk, or any type of recording medium readable by a computer) in which a computer program product is stored, in the form of a set of program code instructions to be executed to modify the reflective properties of the reflective elements of an RIS 20_i. Alternatively or additionally, the command module can include one or more programmable logic circuits (FPGA, PLD, etc.), and/or one or more application-specific integrated circuits (ASIC, etc.), and/or an assembly of discrete electronic components etc., suitable for carrying out all or part of the modifications of the reflective properties of the elements of an RIS 20_ij.

Note that the term “modifications of the reflective properties of the reflective elements of an RIS 20_i” refers in this disclosure to the fact of modifying the phase shifts respectively introduced by the reflective elements of said RIS 20_i.

Note also that the phase shifts (i.e. phase shift values) used by the command module of an RIS 20_i to modify said reflective properties are not determined, in the embodiment described here, by the command module itself, but by a device external to the RISs 20_i, the so-called “control device 22”, belonging to the wireless communication system 20 and described in more detail below. These provisions are however not limiting of the disclosed technology, and nothing precludes the envisioning of all or part of the RISs 20_i being equipped with such a control device so as to be able to autonomously determine phase shifts.

The reflective elements of an RIS 20_i can be of any type known to those skilled in the art. Different RISs of the system 20 may in particular use different types of elements, or else the same type of elements.

Note that the number of elements per RIS 20_i may vary from one RIS to another. However, nothing precludes, according to certain examples, having the same number of elements for all the RISs 20_i.

In the remainder of the description, N_{20_j} denotes the number of reflective elements of the intermediate RIS 20_j. It is also considered, without any limitation, that a reflective element of an intermediate RIS 20_j is of square shape, the length of one side of the square being hereinafter written L_{20_j}. It will be however be understood that these considerations are not limiting of the disclosed technology, and that, insofar as each intermediate RIS 20_j can be likened to a two-dimensional surface, for example of rectangular shape, nothing precludes the distinguishing of the lengths of a reflective element of an intermediate RIS 20_j along two directions x and y representative of the main directions in which the intermediate RIS 20_j extends. Note that the axes bearing the directions x and y thus form a frame of reference attached to the intermediate RIS 20_j (the direction written z being the one orthogonal to the plane formed by the directions x and y).

As mentioned above, the rank of the matrix of the propagation channel between the base station 21 and the main RIS 20_4 can be improved if the intermediate RISs 20_j are spatially distributed with respect to the base station 21 and/or with respect to the main RIS 20_4, i.e. if said intermediate RISs 20_j are arranged in different respective directions with respect to:
the base station 21, i.e. if the angle measured at the base station 21 between the directions of two intermediate RISs 20_j, 20_j′ (j and j′ being two distinct indices) is non-zero (for example greater than 5° or greater than 10°) for each pair of intermediate RISs 20_j, 20_j′; and/or
the main RIS 20_4, i.e. if the angle measured at the main RIS 20_4 between the directions of two intermediate RISs 20_j, 20_j′ is non-zero (for example greater than 5° or greater than 10°) for each pair of intermediate RISs 20j, 20_j′.

Note that the direction of an intermediate RIS 20_j with respect to the base station 21 (or with respect to a main RIS 20_4 respectively) corresponds to the direction along which radio signals emitted by the base station 21 (or reflected by the intermediate RIS 20_j respectively) arrive at the intermediate RIS 20_j (or depart from the intermediate RIS 20_j respectively) to be reflected toward the main RIS 20_4. In other words, it is the direction of the vector connecting the base station 21 (or the intermediate RIS 20_j respectively) to the intermediate RIS 20_j (or to the main RIS 20_4 respectively) in a situation of direct line of sight (LOS). This vector can in particular be characterized angularly by means of different components (elevation, azimuth, and where applicable polarization), as will be described in detail further on.

It should however be noted that, in the event of no direct path existing between the base station 21 (or the intermediate RIS 20_j respectively) and the intermediate RIS 20_j (or the main RIS 20_4 respectively), the direction between these two entities is then defined based on the main indirect path (i.e. the most energetic) connecting them.

Preferably, in particular in the case where the exchanges of data with the user terminals use high frequencies (for example greater than 30 GHz or even greater than 1 THz):
the base station 21 is in a situation of direct line of sight (LOS) with all or part of the intermediate RISs 20_j, and/or
the main RIS 20_4 is in a situation of direct line of sight (LOS) with all or part of the geographical area ZG_4 to be served, and/or
the main RIS 20_4 is in a situation of direct line of sight (LOS) with all or part of the intermediate RISs 20_j.

In practice, to improve the rank of the matrix of the propagation channel between the base station 21 and the main RIS 20_4, it is possible to determine optimal positions of the different intermediate RISs 20_j by simulation, for example by using a 3D model of the environment in which said intermediate RISs 20_j must be installed. It is also possible to carry out rank tests by physically installing the different intermediate RISs 20_j in possible positions of the environment and to keep, from among all the tested possible positions, the positions for which the best rank was obtained.

Whatever the circumstances, in the context of this disclosed technology, it is considered that the RISs 20_i are fixed, their respective positions being, for example, the result of such a procedure consisting in seeking appropriate sites for improving the rank of the matrix of the propagation channel between the base station 21 and the main RIS 20_4.

As indicated above, the wireless communication system 20 also includes a control device 22 configured to carry out processing making it possible to determine phase shifts (i.e. phase shift values) intended to be used by the respective command modules of the intermediate RISs 20_j, by implementing a control method according to the disclosed technology.

In this embodiment, the control device 22 is external to the RIS 20_i of the set E and also to the base station 21. However, nothing precludes the envisioning of the control device 22 being incorporated into the base station 21.

FIG. 4 schematically represents an example of a hardware architecture of the control device 22 belonging to the system 20 of FIG. 3.

As illustrated by FIG. 4, the control device 22 has the hardware architecture of a computer. Thus, the control device 22 includes, in particular, a processor 22_1, a random access memory 222, a read-only memory 223 and a non-volatile memory 22_4. It also possesses communication means 22_5.

The read-only memory 22_3 of the control device 22 constitutes a recording medium in accordance with the disclosed technology, readable by the processor 22_1 and on which is recorded a computer program PROG_22 in accordance with the disclosed technology, including instructions for executing steps of the control method. The program PROG_22 defines functional modules of the control device 22, which are based on or command the hardware elements 22_1 to 22_5 of the control device 22 mentioned previously. These functional modules are illustrated on FIG. 4 without any limitation, and are described in more detail below with reference to different embodiments.

The communication means 22_5 in particular allow the control device 22 to exchange data with any equipment item of the wireless communication system 20, including in particular the intermediate RISs 20_j and the main RIS 20_4 of the set E via a backhaul network. For this purpose, the communication means 22_5 include a communication interface, wired or wireless, able to implement any suitable protocol known to those skilled in the art.

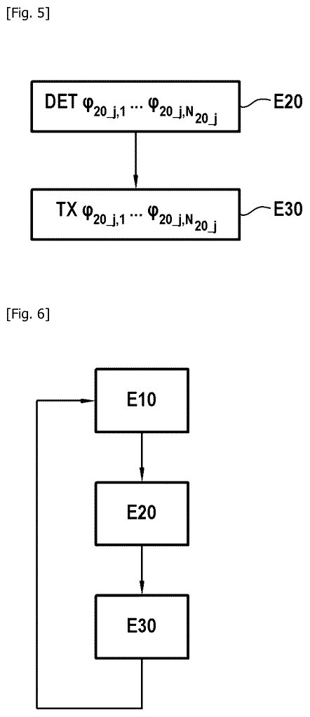

FIG. 5 represents, in the form of a block diagram, a particular embodiment of the control method executed by the control device 22.

For the remainder of the description of the control method, the following notations are introduced.

ψ_{21→20_j} denotes a vector, the so-called “vector of angles of incidence”, corresponding to the direction of an incident wave coming from the base station 21 and directed toward an intermediate RIS 20_j. This vector includes three components θ_{21→20_j}, ϕ_{21→20_j}, ω_{21→20_j} respectively corresponding to the elevation, azimuth and polarization associated with said direction.

ψ_{20_j→20_4} denotes a vector, the so-called “vector of angles of arrival”, corresponding to the direction of a wave reflected by an intermediate RIS 20_j toward the main RIS 20_4. This vector includes two components θ_{20_j→20_4}, ϕ_{20_j→20_4} respectively corresponding to the elevation and the azimuth associated with said direction.

A_{21→20_j} denotes a matrix representative of the directions of waves transmitted by the base station 21 toward the N_{20_j} elements of a reflection of an intermediate RIS 20_j. Each column of the matrix A_{21→20_j} corresponds to a steering vector of an existing transmission path between the base station 21 and the intermediate RIS 20_j.

D_{20_j→20_4} denotes a matrix representative of the directions of the waves reflected by the N_{20_j} reflective elements of an intermediate RIS 20_j toward the N_{20_j→20_4} reflective elements of the main RIS 20_4. Each column of the matrix D_{20_j→20_4} corresponds to a steering vector of an existing transmission path between the intermediate RIS 20_j and the main RIS 20_4.

$${B}_{x} ( {ψ}_{21 \to 20 \_ j} ) = sin {θ}_{21 \to 20 \_ j} cos {ϕ}_{21 \to 20 \_ j}$$

$${B}_{y} ( {ψ}_{21 \to 20 \_ j} ) = sin {θ}_{21 \to 20 \_ j} sin {ϕ}_{21 \to 20 \_ j}$$

$${B}_{z} ( {ψ}_{21 \to 20 \_ j} ) = cos {θ}_{21 \to 20 \_ j}$$

$${B}_{x} ( {ψ}_{20 \_ j \to 20 \_ 4} ) = sin {θ}_{20 \_ j \to 20 \_ 4} cos {ϕ}_{20 \_ j \to 20 \_ 4}$$

$${B}_{y} ( {ψ}_{20 \_ j \to 20 \_ 4} ) = sin {θ}_{20 \_ j \to 20 \_ 4} sin {ϕ}_{20 \_ j \to 20 \_ 4}$$

$${B}_{z} ( {ψ}_{20 \_ j \to 20 \_ 4} ) = cos {θ}_{20 \_ j \to 20 \_ 4}$$

$${B}_{p} = {B}_{p} ( {ψ}_{21 \to 20 \_ j} ) + {B}_{p} ( {ψ}_{20 \_ j \to 20 \_ 4} ) , ∀ p ∈ \{ x , y , z \}$$

$${B}_{x , z} = cos {ω}_{21 \to 20 \_ j} {B}_{x} ( {ψ}_{21 \to 20 \_ j} ) + sin {ω}_{21 \to 20 \_ j} {B}_{z} ( {ψ}_{21 \to 20 \_ j} )$$

Q_{20_j} denotes a diagonal matrix representative of the phase shifts applied to each of the N_{20_j} reflective elements of an intermediate RIS 20_j, and can be expressed in the following form:

$${Q}_{20 \_ j} = diag ( \overline{{g}_{20 \_ j}} {e}^{i {φ}_{20 \_ j , 1}} , ⋯ , \overline{{g}_{20 \_ j}} {e}^{i {φ}_{20 \_ j , {N}_{20 \_ j}}} )$$

an expression in which:
i is the complex number which when squared is equal to −1,
φ_{20_j,k} corresponds to the phase shift introduced by the reflective element of index k of the intermediate RIS 20_j (k=1, . . . , N_{20_j}),

$$- \overline{{g}_{20 \_ j}} = \frac{\sqrt{4 π}}{λ} {g}_{20 \_ j} ,$$

where λ corresponds to the wavelength,

$$- {g}_{20 \_ j} = \frac{i \sqrt{4 π} \times τ \times {L}_{20 \_ j}^{2}}{λ} sin c ( \frac{π {L}_{20 \_ j} {B}_{x}}{λ} ) sin c ( \frac{π {L}_{20 \_ j} {B}_{z}}{λ} ) ,$$

where sinc corresponds to the sine cardinal function, and τ corresponds to a coefficient of reflection of each reflective element of the intermediate RIS 20_j (this coefficient t is between 0 and 1, and is assumed to be constant for all the reflective elements in this embodiment). As can be seen from this formula, the parameter g_{20_j} is in particular expressed as a function of geometrical characteristics of the reflective elements of the intermediate RIS 20_j, more specifically in this example as a function of the dimensional characteristic L_{20_j},
[symbol] is equal to the following quantity:

$$\frac{{B}_{y}}{\sqrt{{B}_{x , z}^{2} + {B}_{y}^{2}}} {‖ \begin{matrix}cos {θ}_{20 \_ j \to 20 \_ 4} ( cos {ω}_{21 \to 20 \_ j} sin {ϕ}_{20 \_ j \to 20 \_ 4} - sin {ω}_{21 \to 20 \_ j} cos {ϕ}_{20 \_ j \to 20 \_ 4} ) \\ sin {ω}_{21 \to 20 \_ j} sin {θ}_{21 \to 20 \_ j} + cos {ω}_{21 \to 20 \_ j} cos {ϕ}_{21 \to 20 \_ j}\end{matrix} ‖}_{2}$$

where ∥⋅∥₂ denotes the Euclidian norm.

For the remainder of the description, it will also be considered without any limitation that the control device 22 has knowledge of the vectors ψ_{21→20_j}, ψ_{20_j→20_4}, as well as the matrices A_{21→20_j}, D_{20_j→20_4} for each of the intermediate RISs 20_j. These different data are for example stored in the non-volatile memory 224 of the control device 22.

These considerations are not however limiting of the disclosed technology, which can cover yet other embodiments in which all or part of said data are obtained by the control device 22 coming from another entity (in which case the control method includes a corresponding reception step), and/or all or part of said data are determined by the control device 22 (in which case the control method includes a corresponding determining step).

In this embodiment, the control method includes, for each intermediate RIS 20_j, a step E20 of determining respective phase shifts of the reflective elements of said intermediate RIS 20_j. Said step E20 is implemented by a determining module MOD_DET equipping the control device 22.

As already mentioned above, said phase shifts are determined such that signals emitted by the base station 21 are reflected by said intermediate RIS 20_j toward the main RIS 20_4 to exchange data with the user terminals situated in the geographical area ZG_4.

Moreover, said phase shifts are also determined such that the power of the signals reflected by said intermediate RIS 20_j toward the main RIS 20_4 is greater than a given threshold or maximized.

To do this, the power of the signals reflected by said intermediate RIS 20_j toward the main RIS 20_4 is considered as being a function parameterized by:
said phase shifts (these latters therefore playing the role of optimization variables in the context of said step E20),
the angles of incidence of the signals emitted by the base station 21 toward said intermediate RIS 20_j,
the angles of departure of the signals reflected by said intermediate RIS 20_j toward the main RIS 20_4.

The fact of determining the phase shifts of the intermediate RISs 20_j in this way makes it possible to take into account the precise physical reality in which said intermediate RIS 20_j is located. This physical reality here refers to the angles of incidence and departure with which signals arrive at/are reflected by the intermediate RIS 20_j. Proceeding in this way makes it possible to configure the intermediate RIS 20_j advantageously so that the reflection of signals toward the main RIS 20_4 is carried out in a much more directed and concentrated way than in the prior art.

Considering the notations introduced previously, the response (i.e. the behavior in terms of phase and amplitude modulation) of the intermediate RIS 20_j vis-h-vis incident signals coming from the base station 21 and reflected toward the main RIS 20_4 can for example be modelled in the form of a matrix G_{20_j→20_4} of which the term situated at row l1 and at column l2 can be expressed in the following form:

$${[ {G}_{20 \_ j \to 20 \_ 4} ]}_{{l}_{1} , {l}_{2}} = {d}_{20 \_ j \to 20 \_ 4}^{H} ( {ψ}_{20 \_ j \to 20 \_ 4}^{{l}_{1}} ) \times {Q}_{20 \_ j} ( {ψ}_{21 \to 20 \_ j}^{{l}_{2}} , {ψ}_{20 \_ j \to 20 \_ 4}^{{l}_{1}} ) \times {a}_{21 \to 20 \_ j} ( {ψ}_{21 \to 20 \_ j}^{{l}_{2}} )$$

an expression in which:
H denotes the conjugate transpose operator,
ψ_{21→20_j}^{l}^{₂} is the l2-th column of the vector ψ_{21→20_j}_,
ψ_{20_j→20_4}^{l}^{₁} is the l1-th column of the vector ψ_{20_j→20_4},
d_{20_j→20_4}^{H}(ψ_{20_j→20_4}^{l}^{₁}) is the l1-th column of the matrix D_{20_j→20_4},
a_{21→20_j}(ψ_{21→20_j}^{l}^{₂}) is the l2-th column of the matrix A_{21→20_j}

Ultimately, the power of the signals reflected by said intermediate RIS 20_j toward the main RIS 20_4 is a function of the squared modulus of said terms [G_{20_j→20_4}]ₗ_{₁}_{,l}_{₂}. Consequently, the determination of the respective phase shifts of the reflective elements of said intermediate RIS 20_j can be done by solving an optimization problem.

For example, in the scenario where one is seeking for the phase shifts to be determined such that the power of the signals reflected by said intermediate RIS 20_j toward the main RIS 20_4 is maximized, said optimization problem to be solved, hereinafter written “PB1”, is as follows:

$$\begin{matrix}max \\ γ , {φ}_{20 \_ j , 1} … {φ}_{20 \_ j , {N}_{20 \_ j}}\end{matrix} γ$$

where |[G_{20_j→20_4}]ₗ_{₁}_{,l}_{₂}|²>γ, ═l₁,l₂ and φ_{20_j,k}ϵ[0,2π],∀k.

Note that the parameter γ here corresponds to an intermediate parameter representative of the lower bound of the quantity |[G_{20_j→20_4}]ₗ_{₁}_{,l}_{₂}|², ∀l₁,l₂. Here the optimization problem PB1 thus has the more specific aim of maximizing this lower bound.

Any optimization method known to those skilled in the art to solve such a problem PB1 may be envisioned, the choice of a particular method being only one variant implementation of the disclosed technology.

According to another example, in the scenario where one is seeking for the phase shifts to be determined such that the power of the signals reflected by said intermediate RIS 20_j toward the main RIS 20_4 is greater than a given threshold γ, said optimization problem to be solved, hereinafter written “PB1_BIS”, consists in finding the phase shifts φ_{20_j,1} . . . φ_{20_j,1} . . . φ_{20_j,N}_{_{20_j}} such that |[G_{20_j→20_4}]ₗ_{₁}_{,l}_{₂}|²>γ,∀l₁,l₂ and φ_{20_j,k} ϵ[0,2π], ∀k.

In the remainder of the text, once the phase shifts φ_{20_j,1} . . . φ_{20_j,N}_{_{20_j}} have been determined for each of the intermediate RISs 20_j (i.e. after iteration of the step E20 for each of the intermediate RISs 20_j), said phase shifts φ_{20_j,1} . . . φ_{20_j,N}_{_{20_j}} are transmitted to each of said intermediate RISs 20_j during a controlling step E30. Said step E30 is implemented by a transmission module MOD_TX equipping the control device 22 and incorporated into the communication means 22_5.

It should be noted that the transmission of said phase shifts φ_{20_j,1} . . . α_{20_j,N}_{_{20_j}} toward each of said intermediate RISs 20_j (i.e. toward each of the command modules equipping said intermediate RISs 20_j) as such constitutes a controlling of these latters in this embodiment since, on receiving said phase shifts φ_{20_j,1} . . . φ_{20_j,N}_{_{20_j}}, each reflective element applies the phase shift which corresponds to it, as already mentioned above. It should however be noted that the term “controlling” in “controlling step E30” can take on another significance in other embodiments in which the command device of an intermediate RIS 20_j is itself in charge of the determination of said phase shifts φ_{20_j,1} . . . φ_{20_j,N}_{_{20_j}} (i.e. in this scenario, the “controlling” no longer includes the transmission of the phase shifts φ_{20_j,1} . . . φ_{20_j,N}_{_{20_j}} and is done in its entirety at each of the intermediate RISs 20j).

It should moreover be noted that the control method has been described up until now by considering that the phase shifts are first determined for the set of the intermediate RISs 20_j, then transmitted to each of these latters. Of course, nothing precludes the envisioning of the phase shifts intended for a given intermediate RIS 20_j being transmitted from it as soon as they have been determined (i.e. without waiting for the phase shifts of the other intermediate RISs to have also been determined).

Moreover, it will be understood that if each intermediate RIS 20_j is configured to reflect signals coming from the base station 21 toward the main RIS 20_4, there may be a risk of some of these reflections being uncontrolled so as to be ultimately directed elsewhere, such as for example toward another intermediate RIS 20_j′ or else directly toward a user terminal. For this purpose, and advantageously, it is possible to envision other more specific examples of step E20 in which the interference vis-h-vis the other intermediate RISs and/or vis-h-vis user terminals are reduced.

For example, the phase shifts associated with an intermediate RIS 20_j can also be determined (i.e. in addition to seeking a maximization of the power of the signals reflected by said intermediate RIS 20_j toward the main RIS 20_4) such that the power of signals reflected by said intermediate RIS 20_j toward at least one other intermediate RIS 20_j′ is minimized (the contribution of the intermediate RIS 20_j toward said at least one other intermediate RIS 20_j′ is symbolized by the parameter si in the remainder of the text). Once again using the notations introduced previously, the corresponding optimization problem, hereinafter written “PB2”, can then be formulated as follows:

$$\begin{matrix}max \\ γ , {β}_{1} , {φ}_{20 \_ j , 1} … {φ}_{20 \_ j , {N}_{20 \_ j}}\end{matrix} γ - {β}_{1}$$

where:
   |[G_{20_j→20_4}]ₗ_{₁}_{,l}_{₂}|²>γ, ∀l₁,l₂
φ_{20_j,k} ϵ[0,2π], ∀k,
   |[G_{20_j→20_j′}]ₗ_{₃}_{,l}_{₂}|²<β₁, ∀l₂,l₃

In this optimization problem PB2, the matrix G_{20_j→20_j′} models the response (i.e. the behavior in terms of phase and amplitude modulation) of the intermediate RIS 20_j vis-h-vis the incident signals coming from the base station 21 and reflected toward another intermediate RIS 20_j′. The determination of the terms of this matrix G_{20_j→20_j}, can be done according to similar formulae to those given above for the matrix G_{20_j→20_4}. It will of course be understood that the power restriction concerning the matrix G_{20_j→20_j′} in the optimization problem PB2 above, can be replicated for any index j′ different from the index j.

According to another example, in the scenario where one is seeking for the phase shifts to be determined such that the power of signals reflected by the intermediate RIS 20_j toward at least one other intermediate RIS 20_j′ is less than a given threshold β₁, said optimization problem to be solved, hereinafter written “PB2_BIS”, consists in finding the phase shifts φ_{20_j,1} . . . φ_{20_j,N}_{_{20_j}} such that |[G_{20_j→20_4}]ₗ_{₁}_{,l}_{₂}|²>γ, ∀l₁,l₂, φ_{20_j,k} ϵ[0,2π], ∀k and |[G_{20_j→20_j′}]ₗ_{₃}_{,l}_{₂}|²<β₁, ∀l₂,l₃.

Alternatively, the phase shifts associated with an intermediate RIS 20_j may also be determined such that the power of signals reflected by said intermediate RIS 20_j directly toward at least one user terminal situated in the geographical area ZG_4 is minimized (the contribution of the intermediate RIS 20_j toward a user terminal situated in the geographical area ZG_4 is symbolized by the parameter β₂ in the remainder of the text). Once again using the notations introduced previously, and also writing U_m an m-th user of the geographical area ZG_4, the corresponding optimization problem, hereinafter written “PB3”, can be formulated as follows:

$$\begin{matrix}max \\ γ , {β}_{2} , {φ}_{20 \_ j , 1} … {φ}_{20 \_ j , {N}_{20 \_ j}}\end{matrix} γ - {β}_{2}$$

where:
   |[G_{20_j→20_4}]ₗ_{₁}_{,l}_{₂}|²>γ, ∀l₁,l₂
φ_{20_j,k} ϵ[0,2π], ∀k,
   |[G_{20_j→U_m}]ₗ_{₄}_{,l}_{₂}|²<β₂, ∀l₂,l₄.

In this optimization problem PB3, the matrix G_{20_j→U_m} models the response (i.e. the behavior in terms of phase and amplitude modulation) of the intermediate RIS 20_j vis-h-vis the incident signals coming from the base station 21 and directly reflected toward a user U_m. The determination of the terms of this matrix G_{20_j→U_m} can be done according to similar formulae to those given above for the matrix G_{20_j→20_4}. It will of course be understood that the power restriction concerning the matrix G_{20_j→U_m} in the optimization problem PB3 above can be replicated for any index m relating to the users present in the geographical area ZG_4.

According to yet another example, in the scenario where one is seeking for the phase shifts to be determined such that the power of signals reflected by said intermediate RIS 20_j directly toward at least one user terminal situated in the geographical area ZG_4 is less than a given threshold β₂, said optimization problem to be solved, hereinafter written “PB3_BIS”, consists in finding the phase shifts φ_{20_j,1} . . . φ_{20_j,N}_{_{20_j}} such that |[G_{20_j→20_4}]ₗ_{₁}_{,l}_{₂}|²>γ, ∀l₁,l₂, φ_{20_j,k} ϵ[0,2π], ∀k and |[G_{20_j→U_m}]ₗ_{₄}_{,l}_{₂}|²<β₂, ∀l₂,l₄.

It is also important to note that, according to yet other embodiments of the control method, the phase shifts of the reflective elements of an intermediate RIS 20_j may be determined by combining all or part of the optimization problems described previously. Put still otherwise, all the restrictions mentioned previously (power reflected toward the main RIS 20_4 greater than a threshold or maximized, power reflected toward a user U_m less than a threshold or minimized, power reflected toward another intermediate RIS 20_j′ less than a threshold or minimized) may be taken into account according to any technically operable combination.

The disclosed technology has been described until now by considering that a predefined role has been assigned, prior to the implementation of the control method, to each RIS 20_i of the set E, and that this role is kept over time. More specifically, it has been considered that the RIS 20_4 pays a role of main RIS and that consequently the other RISs 20_j of the set E each play a role of intermediate RIS.

These provisions are however non-limiting of the disclosed technology which also covers modes in which the respective roles (intermediate, main) played by the RISs 20_i of the set E may be modified, as is now described.

FIG. 6 represents, in the form of a block diagram, another particular embodiment of the control method executed by the control device 22.

In the embodiment of FIG. 6, the control method includes, prior to the transmitting step E30, a step E10 of selecting, from among the RISs 20_i of the set E, at least one RIS as intermediate RIS and at least one RIS as main RIS. In other words, this equates to determining, for each RIS 20_i of the set E, a role to be played as intermediate RIS or main RIS. Said step E10 is implemented by a selecting module MOD_SEL equipping the control device 22.

Each RIS, the role of which is determined as being that of an intermediate RIS is then associated with at least one RIS, the role of which is determined as being that of a main RIS, for the purpose of reflecting toward it incident signals coming from the base station 21.

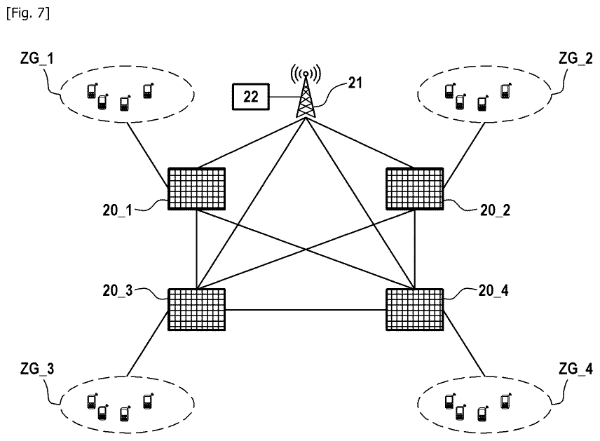

Note that insofar as each RIS 20_i of the set E is able to play a role of main RIS due to the execution of said step E10, each of said RIS 20_i is associated with a given geographical area ZG_i of the cell covered by the base station 21 and is intended to serve this latter when the role of main RIS is effectively assigned to it. The geographical areas ZG_i respectively associated with the RIS_i of the set E are distinct from one another. These aspects are in particular represented schematically and solely by way of example in FIG. 7.

Moreover, in the embodiments described here, the selection of each of the RISs 20_i as intermediate or main RIS is done so as to optimize a determined communication performance criterion KPI for user terminals situated in the geographical area served by each RIS selected as main RIS.

No limitation is attached to the nature of the criterion KPI, and the choice of a particular type of criterion KPI corresponds to only one possible variant of the disclosed technology.

For example, the criterion KPI is representative of at least one element from among:
a bitrate of the data which can be exchanged between the base station 21 and the user terminals situated in the geographical area served by each main RIS. In this scenario, the optimization of the criterion KPI for example has the aim of maximizing said bitrate;
a level of quality of service of the exchanges of data between the base station 21 and the user terminals situated in the geographical area served by each main RIS. In this scenario, the optimization of the criterion KPI for example has the aim of maximizing said level of quality of service (for example by minimizing the latency of the exchanges);
an energy required to make exchanges of data between the base station 21 and the user terminals situated in the geographical area served by each main RIS. In this scenario, the optimization of the criterion KPI for example has the aim of minimizing the energy required to make said exchanges of data;
a signal-to-noise ratio of the exchanges of data between the base station 21 and the user terminals situated in the geographical area served by each main RIS. In this scenario, the optimization of the criterion KPI for example has the aim of having a signal-to-noise ratio greater than a determined or maximized threshold.

The optimization problem to be solved during the execution of the step E10 can be expressed in different ways, firstly according to the criterion KPI taken into consideration, but also optionally according to the taking into account of restrictions which may concern the criterion KPI chosen (maximization/minimization of a physical quantity etc.) but also other aspects such as for example:
a distribution of user terminals between all or part of the geographical areas respectively associated with the RIS 20_i of the set E, and/or
a priority of service of all or part of the geographical areas respectively associated with the RIS 20_i of the set E, and/or
a minimal equity of service between all or part of the geographical areas respectively associated with the RIS 20_i of the set E (for example, one ensures that, over a determined time period, each area has been served a given number of times).

As mentioned above, the step E10 is implemented before the transmitting step E30. That being said, the step E20 of determining the phase shifts can itself be implemented during the execution of the step E10 (not shown on FIG. 6) or else after said step E10 has been executed. Specifically, the optimization of the criterion KPI can for example consist in testing all the possible configurations in terms of roles assigned to the different RIS 20_i of the set E, and, for a given configuration, evaluating the criterion KPI based on quantities computed during the execution of step E20.

Now, whether step E20 is executed during step E10 or else after step E10, it is important to remember that this step E20 concerns only the control of the reflective elements of the intermediate RISs 20_j. The configuration of the reflective elements of an RIS selected as the main RIS, to meet a criterion KPI relating to user terminals, itself falls within the category of separate technical considerations already known to those skilled in the art. and which are for example described in the following document: “Distributed RIS-aided Joint Spatial Division and Multiplexing,” 2023 IEEE 34th Annual International Symposium on Personal, Indoor and Mobile Radio Communications (PIMRC), Toronto, ON, Canada, 2023, pp. 1-7”.

Whatever the circumstances, and in general, any method of optimization of the criterion KPI may be envisioned, the choice of a particular method corresponding only to one variant implementation of the disclosed technology.

Moreover, and as illustrated by FIG. 6, the steps E10, E20, E30 together form a set of steps which can be iterated. Proceeding in this way makes it possible to modify the distribution of the roles played by the RIS 20_i of the set E, which offers the advantageous possibility of effectively serving all the geographical areas respectively associated with said RIS 20_i of the set E.

For example, said set of steps is iterated according to a determined time increment corresponding to the coherence time associated with the signals emitted by the base station 21 or with the signals emitted by the user terminal or terminals.

According to another example, said set of steps is iterated according to a determined time increment corresponding to a determined slot of said coherence time.

A description will now follow of different exemplary implementations of the step E10 of determining the roles. More specifically, a description will follow of different formulations of the criterion KPI optimization problem, which may be envisioned during the execution of the step E10.

According to a first example, the following optimization problem can be solved:

$${max}_{{x}_{1} … {x}_{I}} {\sum }_{i = 1}^{I} {\sum }_{m = 1}^{{M}_{i}} {x}_{i} {KPI}_{i , m}$$

where:
KPI_{i,m} is the performance criterion KPI related to a user terminal U_m served by the RIS 20_i,
Σᵢ₌₁^{k}xᵢ≤1, with xᵢϵ{0,1}∀i, and I corresponds to the number of RISs 20_i belonging to the system 20 (I=4 in the context of this description),
xᵢ equal to 1 (or equal to 0 respectively) indicates that the RIS 20_i is playing the role of a main RIS (or of an intermediate RIS respectively),
Mᵢ corresponds to the number of user terminals situated in the geographical area ZG_i served by the RIS 20_i when it plays the role of main RIS.

Note that in this first example, Mᵢ user terminals are considered as served by the RIS 20_i at the time of solving of the criterion KPI optimization problem. More specifically, these user terminals correspond, in this first example, to predetermined terminals that said RIS 20_i is intended to serve if its role is determined as being that of main RIS. The Mᵢ user terminals concerned can be determined using any method known to those skilled in the art (channel estimate, determination and use of an item of information of CSI type, etc.). In addition, the determination of said Mᵢ terminals can be the subject of a determining step incorporated into the control method and executed prior to the step E10 of determining the roles.

Whatever the circumstances, the fact that the user terminals taken into consideration when solving the criterion KPI optimization problem are predetermined for each RIS 20_i of the set E does not constitute a limitation of the disclosed technology. For this purpose, and according to a second example, the optimization of the performance criterion KPI can take into account, as optimization variable and for each user terminal situated in the geographical area served by a main RIS, a parameter representative of the fact that said user terminal is served or not. The associated optimization problem is for example formulated as follows:

$${max}_{{x}_{i} , {y}_{m}^{i} ∀ i , m} {\sum }_{i = 1}^{I} {x}_{i} {\sum }_{m = 1}^{M} {y}_{m}^{i} {KPI}_{i , m}$$

where:
KPI_{i,m} is the performance criterion KPI related to a user terminal U_m served by the RIS 20_i,
Σᵢ₌₁^{l}xᵢ≤1, with xᵢϵ{0,1}∀i,
xᵢ equal to 1 (or equal to 0 respectively) indicates that the RIS 20_i plays the role of a main RIS (or of an intermediate RIS respectively),
Σₘ₌₁^{M}yₘⁱ≤Mᵢ_{ₘₐₓ}, ∀i and yₘⁱϵ{0,1}∀i, m,
yₘⁱ equal to 1 (or equal to 0 respectively) indicates that a user terminal U_m is served (or is not served respectively) by the RIS 20_i, and where Mᵢ_{ₘₐₓ} corresponds to a given maximum number of user terminals which can be served by the RIS 20_i,
M=Σᵢ₌₁^{l}Mᵢ, where Mᵢ corresponds to the number of user terminals situated in the geographical area ZG_i served by the RIS 20_i when it plays the role of main RIS.

The optimization problem as formulated in this second exemplar implementation makes it possible to take more account of the fact that the user terminals have a dynamic within the communication cell served by the base station 21.

The formulations of the criterion KPI optimization problems described until now in the first and second examples are based on the fact that a single RIS from among the RIS 20_i of the set E can play the role of main RIS. The disclosed technology is however not limited by these aspects, and nothing precludes the envisioning of the optimization of the performance criterion KPI being parameterized such that the determination of a plurality of main RISs is allowed from among the RIS 20_i of the set E. For this purpose, and according to a third example, the following optimization problem can be solved:

$${max}_{{x}_{ij} , {y}_{m}^{i} ∀ i , j , m} {\sum }_{i = 1}^{I} {\sum }_{m = 1}^{M} {KPI}_{i , m} ( {x}_{ij} , {y}_{m}^{i} )$$

where:
Σⱼ₌₁¹, xᵢⱼ≤1, ∀i, with xᵢⱼ ϵ{0,1}∀i,j,
xᵢⱼ(i≠j) equal to 1 indicates that the RIS 20_i plays the role of an intermediate RIS vis-à-vis the RIS 20_j which plays the role of main RIS,
xᵢᵢ equal to 1 (or equal to 0 respectively) indicates that the RIS 20_i plays the role of a main RIS (or of an intermediate RIS respectively),
xᵢⱼ+xⱼᵢ≤1, ∀i, j, i≠j and xⱼᵢ≤xᵢᵢ, ∀i, j, i≠j,
KPI_{i,m} is the performance criterion KPI related to a user terminal U_m served by the RIS 20_i when the encoded distribution between main RISs and intermediate RISs parameterized by xᵢⱼ is considered,
Σₘ₌₁^{M}yₘⁱ≤Mᵢ_{ₘₐₓ}, ∀i and yₘⁱϵ{0,1}∀i, m,
yₘⁱ equal to 1 (or equal to 0 respectively) indicates that a user terminal U_m is served (or is not served respectively) by the RIS 20_i, and where Mᵢ_{ₘₐₓ} corresponds to a given maximum number of user terminals which can be served by the RIS 20_i,
M=Σᵢ₌₁^{l}Mᵢ, where Mᵢ corresponds to the number of user terminals situated in the geographical area ZG_i served by the RIS 20_i when it plays the role of main RIS.

Note that the different restrictions imposed on the parameters xᵢⱼ, ∀i,j in the optimization problem of this third example have the effect of partitioning the intermediate RISs according to whether they reflect signals toward such and such a main RIS. Put still otherwise, the intermediate RIS or RISs determined to reflect signals toward one main RIS are separate from the intermediate RIS or RISs determined to reflect signals toward another main RIS.

According to a fourth exemplary embodiment, in the more specific scenario where the steps E10, E20 and E30 are iterated according to a time increment corresponding to the coherence time, the optimization of the performance criterion may take into account, as optimization variable and for each RIS 20_i of the set E, a parameter representative of the number of slots of coherence time during which said RIS 20_i plays a role of main RIS. The corresponding optimization problem can for example be formulated as follows:

$${max}_{{x}_{i} , {y}_{m}^{i} ∀ i , m} {\sum }_{i = 1}^{I} {x}_{i} {\sum }_{m = 1}^{M} {y}_{m}^{i} {KPI}_{i , m}$$

where:
KPI_{i,m} is the performance criterion KPI related to a user terminal U_m served by the RIS 20_i,
Σᵢ₌₁^{l}xᵢ=S, with xᵢϵ[[0, S]]∀i, where S corresponds to the number of slots discretizing (dividing up) the coherence time, it being understood that these slots are here of identical sizes
xᵢ strictly greater than 1 (or equal to 0 respectively) indicates that the RIS 20_i plays the role of a main RIS during xᵢ slots of coherence time (or plays the role of an intermediate RIS respectively),
Σₘ₌₁^{M}yₘⁱ≤Mᵢ_{ₘₐₓ}, ∀i and yₘⁱϵ{0,1}∀i, m,
yₘⁱ equal to 1 (or to 0 respectively) indicates that a user terminal U_m is served (or is not served respectively) by the RIS 20_i, and where Mᵢ_{ₘₐₓ} corresponds to a given maximum number of user terminals which can be served by the RIS 20_i,
M=Σᵢ₌₁^{l}Mᵢ, where Mᵢ corresponds to the number of user terminals situated in the geographical area ZG_i served by the RIS 20_i when it plays the role of main RIS.

It will be understood that the optimization problem of this fourth example provides an effective trade-off in terms of optimality/computational load ratio. Specifically, the frequency at which the optimization problem is solved (coherence time) does indeed limit the taking into account of the dynamic of the user terminals, but nonetheless makes it possible to reduce the computational load. Whatever the circumstances, this optimization problem also makes it possible to take into account, via said restriction Σᵢ₌₁^{l}xᵢ=S, of the proportion of time (over the total duration of the coherence time) during which an RIS 20_i plays the role of main RIS, which advantageously contributes to improving said optimality/computational load ratio.

Note that the first, second, third and fourth examples detailed above with reference to the formulation of the optimization problem of the step E10 have been described independently from one another. This being the case, nothing of course precludes the envisioning of the formulation of a criterion KPI optimization problem by taking into account the characteristics of all or part of said first, second, third and fourth examples and according to any technically operable combination.

It should also be noted that if the possibility of having a plurality of main RISs has been described above with reference to the third exemplary implementation of the step E10, the disclosed technology covers yet other modes in which said possibility is also present even though the roles of the different RISs 20_i of the set E are set beforehand (i.e. the step E10 is not implemented in these other modes).

For example, let us consider a embodiment in which the set E includes a plurality of main RISs and at least one intermediate RIS, these roles having been assigned prior to the implementation of the control method. Hence, the step E20 of determining the phase shifts can include the determination, from among the plurality of main RISs, of a main RIS, the so-called “focusing RIS” toward which the intermediate RIS (i.e. the intermediate RIS considered during the execution of the step E20) is intended to reflect signals. This determination of the focusing RIS is done so as to optimize a determined communication performance criterion for antennas situated in the geographical area served by said focusing RIS.

In addition, in this embodiment, the steps E20 of determining the phase shifts and E30 of transmitting the phase shifts together form a set of steps which is iterated.

It will thus be understood that, in this embodiment:
a focusing RIS is associated with each intermediate RIS during each execution of the step E20,
the focusing RISs associated with one and the same intermediate RIS following two executions of the step E20 may differ from one another (this difference resulting from the optimization of the criterion KPI).

In other words, in this embodiment, each intermediate RIS is offered the possibility of reflecting signals to any one of the main RISs, the iterations of the steps E20 and E30 then making it possible to schedule the intermediate RIS/main RIS associations during the different iterations.

By way of example, the optimization problem solved during the step E20 in this embodiment can be formulated as follows:

$${max}_{{x}_{i}^{p} , {y}_{m}^{p} ∀ i , p} {\sum }_{p = 1}^{R} {\sum }_{m = 1}^{M} {y}_{m}^{p} {KPI}_{p , m} ( {x}_{i}^{p} , {y}_{m}^{p} )$$

where:
R is the number of main RISs,
KPI_{p,m} is the performance criterion KPI related to a user terminal U_m served by the RIS 20_p,
Σₚ₌₁^{R}xᵢ^{p}≤1, ∀i with xᵢ^{p} ϵ{0,1}∀i, p,
xᵢ^{p} equal to 1 (or equal to 0 respectively) indicates that the RIS 20_i plays the role of an intermediate RIS associated with the main RIS 20_p (or is disabled respectively),
Σₘ₌₁^{M}<yₘ^{p}≤M_{P}_{ₘₐₓ}, ∀p and yₘ^{p} ϵ{0,1}∀m, p,
yₘ^{p} equal to 1 (or to 0 respectively) indicates that a user terminal U_m is served (or is not served respectively) by the RIS 20_p, and where M_{P}_{ₘₐₓ} corresponds to a given maximum number of user terminals which can be served by the RIS 20_p.

The different aspects of the disclosed technology (controlling the reflective elements of the intermediate RISs 20_j, selecting the roles of the RISs 20_i of the set E) have been described until now by considering a communication downlink between the base station 21 and the user terminals distributed in the different geographical areas ZG_i. However, these arrangements are not limiting of the disclosed technology, and the different aspects of the disclosed technology can also be implemented in the context of a communication uplink between the user terminals and the base station 21.

In this context of a communication uplink between the user terminals and the base station 21, it will then be understood that a main RIS no longer represents a “focusing” surface vis-h-vis the intermediate RISs with which it is associated, but rather a “transmission” (or “broadcasting”) surface, in the sense that said intermediate RISs are intended to receive signals coming from such a transmission main RIS to reflect them toward the base station 21.

Below is a description of the updating of the formulations of the optimization problems PB1, PB2 and PB3 for the context of a communication uplink between the user terminals and the base station 21. Note that each of these optimization problems PB1, PB2 and PB3 allows, in this context of a communication uplink, two formulations according to whether one is considering a technique of transmission of signals by TDD (Time Division Duplex) or FDD (Frequency Division Duplex) multiplexing.

Thus, as regards the optimization problem PB1, it is formulated as follows in the scenario of an uplink TDD transmission (i.e. one is considering one and the same transmission frequency, and thus a fortiori one and the same wavelength λ):

$$\begin{matrix}max \\ γ , {φ}_{20 \_ j , 1} … {φ}_{20 \_ j , {N}_{20 \_ j}}\end{matrix} γ$$

where |[G_{20_j→21}]ₗ_{₁}_{,l}_{₂}|²>γ, ∀l₁,l₂ and φ_{20_j,k} ϵ[0,2π],∀k.

As regards the optimization problem PB1, is formulated as follows in the scenario of an uplink FDD transmission (i.e. one is here considering two distinct transmission frequencies, and thus a fortiori two distinct wavelengths λ1, λ2):

$$\begin{matrix}max \\ γ , {φ}_{20 \_ j , 1} … {φ}_{20 \_ j , {N}_{20 \_ j}}\end{matrix} γ$$

where |[G_{20_j→21}]ₗ_{₂}_{,l}_{₁}|²>γ, ∀l₁,l₂ and φ_{20_j,k} ϵ[0,2π],∀k, |[G_{20_j→20_4}]ₗ_{₁}_{,l}_{₂}|²>γ,∀l₁,l₂ and φ_{20_j,k} ϵ[0,2π], ∀k.

As regards the optimization problem PB2, it is formulated as follows in the scenario of an uplink TDD transmission (i.e. one is considering one and the same transmission frequency, and thus a fortiori one and the same wavelength λ):

$$\begin{matrix}max \\ γ , {β}_{1} , {φ}_{20 \_ j , 1} … {φ}_{20 \_ j , {N}_{20 \_ j}}\end{matrix} γ - {β}_{1}$$

where |[G_{20_j→21}]ₗ_{₁}_{,l}_{₂}|²>γ,∀l₁,l₂ and φ_{20_j,k} ϵ[0,2π],∀k |[G_{20_j′→20_j}]ₗ_{₁}_{,l}_{₃}|²<β₁,∀l₂,l₃.

As regards the optimization problem PB2, it is formulated as follows in the scenario of an uplink FDD transmission (i.e. here one is considering two distinct transmission frequencies, and thus a fortiori two distinct wavelengths λ1, λ2):

$$\begin{matrix}max \\ γ , {β}_{1} , {φ}_{{20}_{j} , 1} … {φ}_{{20}_{j} , {N}_{{20}_{j}}}\end{matrix} γ - {β}_{1}$$

where |[G_{20_j→20_4}]ₗ_{₁}_{,l}_{₂}|²>γ, ∀l₁,l₂ and φ_{20_j,k} ϵ[0,2π],∀k |[G_{20_j→20_j′}]ₗ_{₃}_{,l}_{₂}|²<β₁, ∀l₂,l₃|[G_{20_j→21}]ₗ_{₂}_{,l}_{₁}_{,λ1}|²>γ, ∀l₁,l₂|[G_{20_j→20_j′}]ₗ_{₂}_{,l}_{₃}_{,λ2}|²<β₁, ∀l₂,l₃

As regards the optimization problem PB3, it is formulated as follows in the scenario of an uplink TDD transmission (i.e. one is considering one and the same transmission frequency, and thus a fortiori one and the same wavelength λ):

$$\begin{matrix}max \\ γ , {β}_{2} , {φ}_{{20}_{j} , 1} … {φ}_{{20}_{j} , {N}_{{20}_{j}}}\end{matrix} γ - {β}_{2}$$

where |[G₂₀_{ⱼ}_{→21}]ₗ_{₁}_{,l}_{₂}|²>γ, ∀l₁,l₂ and φ_{20_j,k} ϵ[0,2π],∀k |[G_{20_j→21}]ₗ_{₂}_{,l}_{₄}|²<β₂, ∀l₂,l₄. Note that this latter restriction concerns the response (i.e. the behavior in terms of phase and amplitude modulation) of the intermediate RIS 20_j when one is considering:
incident signals coming directly from user terminals intended to be served by said intermediate RIS 20_j if it is selected as main RIS,
signals departing toward the base station 21 from the intermediate RIS 20_j.

As regards the optimization problem PB3, it is formulated as follows in the scenario of an uplink FDD transmission FDD (i.e. here one is considering two distinct transmission frequencies, and thus a fortiori two distinct wavelengths):

$$\begin{matrix}max \\ γ , {β}_{2} , {φ}_{{20}_{j} , 1} … {φ}_{{20}_{j} , {N}_{{20}_{j}}}\end{matrix} γ - {β}_{2}$$

where |[G_{20_j→20_4}]ₗ_{₁}_{,l}_{₂}_{,λ1}|²>γ, ∀l₁,l₂ and φ₂₀_{ⱼ}_{,k} ϵ[0,2π],∀k |[G_{20_j→U_m}]ₗ_{₁}_{,l}_{₂}_{,λ1}|²<β₂, ∀l₂,l₄|[G_{20_j→21}]ₗ_{₁}_{,l}_{₁}_{,λ2}|²>γ, ∀l₁,l₂|[G_{20_j→21}]ₗ_{₂}_{,l}_{₄}_{,λ2}|²<β₂,∀l₂,l₄. Note that this latter restriction concerns the response (i.e. the behavior in terms of phase and amplitude modulation) of the intermediate RIS 20_j when one is considering:
incident signals coming directly from user terminals intended to be served by said intermediate RIS 20_j if it is selected as main RIS,
signals departing toward the base station 21 from the intermediate RIS 20_j.

The optimization problems PB1_BIS, PB2_BIS and PB3_BIS can of course be reformulated, in this context of a communication uplink, according to similar considerations to those which have just been described for the optimization problems PB1, PB2, PB3.

Although the present disclosure has been described with reference to one or more examples, workers skilled in the art will recognize that changes may be made in form and detail without departing from the scope of the disclosure and/or the appended claims.

What is claimed is:

1. A method for controlling at least one reconfigurable intelligent surface, called an “intermediate surface”, positioned between an access point and at least one other reconfigurable intelligent surface, called a “main surface”, configured to serve a given geographical area covered by the access point, the method being performed by an electronic device and including:
determining phase shifts of reflective elements of said intermediate surface such that:
signals emitted by the access point are reflected by said intermediate surface toward said at least one main surface to exchange data with at least one user terminal situated in the geographical area served by said at least one main surface, and
a power of the signals reflected by said intermediate surface toward said at least one main surface is greater than a given threshold or maximized, said power being a function parameterized by said phase shifts, angles of the signals emitted by the access point toward said intermediate surface, as well as angles of the signals reflected by said intermediate surface toward said at least one main surface; and
controlling the reflective elements of said intermediate surface by using the determined phase shifts.

2. The method as claimed in claim 1, wherein the phase shifts are also determined such that the power of signals reflected by said intermediate surface directly toward at least one antenna of said at least one user terminal is less than a given threshold or minimized.

3. The method as claimed in claim 1, wherein:
the access point is in a situation of direct line of sight with all or part of said at least one intermediate surface, and/or
each main surface is in a situation of direct line of sight with all or part of the geographical area it serves, and/or
all or part of said at least one main surface is in a situation of direct line of sight with all or part of said at least one intermediate surface.

4. The method as claimed in claim 1, said method being implemented to control a plurality of intermediate surfaces positioned between the access point and said at least one main surface, the determining phase shifts and the controlling being executed for each intermediate surface of said plurality of intermediate surfaces.

5. The method as claimed in claim 4, wherein intermediate surfaces are arranged along different respective directions with respect to the access point.

6. The method as claimed in claim 4, wherein intermediate surfaces are arranged along different respective directions with respect to said at least one main surface.

7. The method as claimed in claim 4, wherein the phase shifts are also determined such that the power of signals reflected by the intermediate surface for which phase shifts are determined toward at least one other intermediate surface is less than a given threshold or minimized.

8. The method as claimed in claim 1, wherein a set of reconfigurable intelligent surfaces is associated with the access point, said set including at least one surface selected as the intermediate surface and at least one surface selected as the main surface so as to optimize a determined communication performance criterion for at least one user terminal situated in the geographical area served by said at least one main surface, the determining and the controlling being implemented for the surfaces thus selected in said set of surfaces.

9. The method as claimed in claim 8, wherein the determining the phase shifts and the controlling form a set of steps, said set of steps being iterated and each iteration is implemented for the selected surfaces so as to optimize the communication performance criterion during said iteration.

10. The method as claimed in claim 9, wherein said set of steps is iterated according to a determined time increment corresponding to a coherence time associated with the signals emitted by the access point or by said at least one user terminal, or to a determined slot of said coherence time.

11. The method as claimed in claim 1, wherein a set of reconfigurable intelligent surfaces is associated with the access point, said set including a plurality of main surfaces, the determining the phase shifts including determining, from among the plurality of main surfaces, a main surface called a “focusing surface”, toward which the intermediate surface is intended to reflect signals, said determining of the focusing surface being done so as to optimize a determined communication performance criterion for at least one user terminal situated in the geographical area served by said focusing surface, and wherein the determining the phase shifts and the controlling form a set of steps, said set of steps being iterated.

12. The method as claimed in claim 8, wherein the communication performance criterion is representative of at least one element from among:
a bitrate of the data which can be exchanged between the access point and said at least one user terminal situated in the geographical area served by each selected main surface,
a level of quality of service of the exchanges of data between the access point and said at least one user terminal situated in the geographical area served by each selected main surface,
an energy efficiency of the exchanges of data between the access point and said at least one user terminal situated in the geographical area served by each selected main surface,
a signal-to-noise ratio of the exchanges of data between the access point and said at least one user terminal situated in the geographical area served by each main surface.

13. A control device comprising:
at least one processor; and
at least one non-transitory computer readable medium comprising instructions stored thereon which when executed by the at least one processor configure the control device to control at least one reconfigurable intelligent surface, called an “intermediate surface”, positioned between an access point and at least one other reconfigurable intelligent surface, called a “main surface”, configured to serve a given geographical area covered by the access point, wherein the control comprises:
determining phase shifts of reflective elements of said intermediate surface such that:
signals emitted by the access point are reflected by said intermediate surface toward said at least one main surface to exchange data with at least one user terminal situated in the geographical area served by said at least one main surface, and
a power of the signals reflected by said intermediate surface toward said at least one main surface is greater than a given threshold or maximized, said power being a function parameterized by said phase shifts, angles of the signals emitted by the access point toward said intermediate surface, as well as angles of the signals reflected by said intermediate surface toward said at least one main surface; and
controlling the reflective elements of said intermediate surface by using the determined phase shifts.

14. A method for controlling at least one reconfigurable intelligent surface, called an “intermediate surface”, positioned between an access point and at least one other reconfigurable intelligent surface, called a “main surface”, configured to serve a given geographical area covered by the access point, the method including:
determining phase shifts of reflective elements of said intermediate surface such that:
signals, emitted by at least one user terminal situated in said geographical area and reflected by said at least one main surface toward said intermediate surface, are reflected by said intermediate surface toward the access point to exchange data with the access point, and
a power of the signals reflected by said intermediate surface toward the access point is greater than a given threshold or maximized, said power being a function parameterized by said phase shifts, angles of the signals reflected by said at least one main surface toward said intermediate surface, as well as angles of the signals reflected by said intermediate surface toward the access point; and
controlling the reflective elements of said intermediate surface by using the determined phase shifts.

15. The method as claimed in claim 14, wherein the phase shifts are also determined such that the power of signals reflected by said intermediate surface directly toward at least one antenna of said at least one user terminal is less than a given threshold or minimized.

16. The method as claimed in claim 14, said method being implemented to control a plurality of intermediate surfaces positioned between the access point and said at least one main surface, the determining phase shifts and the controlling being executed for each intermediate surface of said plurality of intermediate surfaces.

17. The method as claimed in claim 16, wherein the phase shifts are also determined such that the power of signals reflected by the intermediate surface for which phase shifts are determined toward at least one other intermediate surface is less than a given threshold or minimized.

18. The method as claimed in claim 14, wherein a set of reconfigurable intelligent surfaces is associated with the access point, said set including at least one surface selected as the intermediate surface and at least one surface selected as the main surface so as to optimize a determined communication performance criterion for at least one user terminal situated in the geographical area served by said at least one main surface, the determining and the controlling being implemented for the surfaces thus selected in said set of surfaces.

19. The method as claimed in claim 14, wherein a set of reconfigurable intelligent surfaces is associated with the access point, said set including a plurality of main surfaces, the determining the phase shifts including determining, from among the plurality of main surfaces, a main surface called a “focusing surface”, toward which the intermediate surface is intended to reflect signals, said determining of the focusing surface being done so as to optimize a determined communication performance criterion for at least one user terminal situated in the geographical area served by said focusing surface, and wherein the determining the phase shifts and the controlling form a set of steps, said set of steps being iterated.

20. The method as claimed in claim 14, wherein a set of reconfigurable intelligent surfaces is associated with the access point, said set including a plurality of main surfaces, the step of determining the phase shifts including the determining, from among the plurality of main surfaces, of a main surface, the so-called “transmitting surface” from which the intermediate surface is intended to receive signals to reflect them toward the access point, said determining of the transmitting surface being done so as to optimize a determined communication performance criterion for at least one user terminal situated in the geographical area served by said transmitting surface, and wherein the steps of determining the phase shifts and controlling form a set of steps, said set of steps being iterated.
